(19) United States
(12) Patent Application Publication
(10) Pub. No.: US 2026/0361119 A1
(43) Pub. Date: Nov. 12, 2026

(54) EMERGENCY LIGHTING

(71) Applicant: JDRF Electromag Engineering Inc., Mississauga (CA)

(72) Inventor: Roumanos DABLEH, Oakville (CA)

(73) Assignee: JDRF Electromag Engineering Inc., Mississauga, ON (CA)

(21) Appl. No.: 19/124,087

(22) PCT Filed: Oct. 31, 2022
(86) PCT No.: PCT/IB2022/060491

§ 371 Date: Apr. 24, 2025

(51) Int. Cl. H02J 9/06; H05B 47/115; H05B 47/16

(52) U.S. Cl. CPC H02J 9/065; H05B 47/115; H05B 47/16

(57) ABSTRACT

An example of an apparatus to provide emergency lighting is provided. The apparatus includes a light source to illuminate a space. In addition, the apparatus include a sensor to detect an external signal. The external signal is powered by a first power source. The apparatus also includes a light source controller to control the light source. The light source controller is to operate the light source in a first state when the sensor detects the external signal. The light source controller is to operate the light source in a second state when the sensor fails to detect the external signal. Furthermore, the apparatus includes a connector to receive power from a second power source. The power is provided to the light source, the light source controller, and the sensor. The second power source is separate from the first power source.

### BACKGROUND

Emergency lighting in a building during a power outage has been provided via various systems over time. Traditional systems may include a rechargeable battery pack, such as a sealed lead battery, nickel cadmium battery, or lithium ion battery, connected to a light source, such as a light bulb or light emitting diode. The rechargeable battery pack may be connected to a power source such as the electrical grid via power outlet or a hardwired connection to charge the rechargeable battery pack and to maintain the state of charge against any self-discharge over time. Upon loss of normal power, such as from an external power grid due to mechanical failure of the delivery system or a natural disaster, the light source is turned on and powered by the rechargeable battery pack.

In modern emergency lighting systems, separate emergency lighting may be replaced with normal light fixtures capable of operating as emergency lighting. The light fixtures are to provide emergency lighting at a sufficient illumination for the safe egress of building occupants and visibility for first responders. For example, where luminaire level lighting control based on occupancy is employed, the occupancy detector is generally overridden so that the luminaire does not shut off while normal power is lost. Currently, the industry primarily employs two broad approaches for emergency lighting control: distributed emergency lighting control and centralized emergency lighting control.

In a distributed emergency lighting control system, each emergency light fixture includes an emergency driver with a battery to power a light source, such as a light emitting diode. Under normal operating conditions, the emergency light fixture is powered from a normal power supply, such as an electrical grid. The emergency driver does not interfere with the operation of the emergency light fixture during normal operating conditions. When normal power is lost, the emergency driver uses energy stored in the battery power itself and the light source. During loss of normal power, the fixture-mounted sensor to control the operation of the light source is overridden such that it does not override the light level emitted by the light source to maintain predetermined illumination levels during a power outage.

In a centralized emergency lighting control, each emergency light fixture is connected to a separate power circuit from a normal light fixture. This separate power circuit may use an auxiliary/back-up power source, such as a generator or central battery, to provide power. Accordingly, the separate power circuit performs as an emergency power distribution circuit or an uninterruptable power supply. The normal power distribution circuit, such as an external power grid, and the emergency power distribution circuit are connected to a transfer switch which supplies power to a plurality of emergency light fixtures. The system typically further includes an additional generator transfer device installed in each emergency light fixture to override the sensor and wall switch during a power outage. The transfer device may detect the loss of normal power and disconnect the sensor from the light source driver by creating a short-circuit across the sensor power supply terminals of the driver.

### BRIEF DESCRIPTION OF THE DRAWINGS

Reference will now be made, by way of example only, to the accompanying drawings in which:

FIG. 1 is a schematic representation of the components of an example of an apparatus to provide emergency lighting;

FIG. 2 is a schematic representation of an example of a building space where a system of the apparatus to provide emergency lighting shown in FIG. 1 and an apparatus to provide normal lighting are deployed;

FIG. 3 is a schematic representation of the components of an apparatus to provide normal lighting;

FIG. 4 is a schematic representation of the components of an example of a power source for the apparatus to provide emergency lighting shown in FIG. 1;

FIG. 5 is a schematic representation of the components of another example of a power source for the apparatus to provide emergency lighting shown in FIG. 1;

FIG. 6 is a schematic representation of the components of another example of an apparatus to provide emergency lighting; and

FIG. 7 is a flowchart of an example of a method of providing emergency lighting.

### DETAILED DESCRIPTION

Emergency lighting has been deployed in buildings to maintain safety in the event of a power outage. Various emergency lighting systems have been used in the past, such as separate lighting systems with a sole purpose of providing lighting when normal power to the light fixtures is lost. Such emergency lighting systems are often bulky and call for a separate installation on a wall or ceiling, taking up additional space as well as potentially being unsightly to the decor of an interior space.

More recently, emergency lighting systems utilize normal light fixtures capable of operating as emergency lighting. The light fixtures are configured to provide emergency lighting at a sufficient illumination for the safe egress of building occupants and visibility for first responders. In general, the light fixtures operate via distributed emergency lighting control or centralized emergency lighting control. In the former system, each emergency light fixture includes an emergency driver with a battery to power a light source, such as a light emitting diode. In the latter system, each emergency light fixture is connected to a separate power circuit from a normal light fixture. This separate power circuit performs as an emergency power distribution circuit or an uninterruptable power supply. In both cases, the distributed and centralized approaches use additional hardware in emergency light fixtures compared to normal light fixtures. In addition, safeguard mechanisms are in place to ensure that the external input, such as from general users, are not capable of overriding control to reduce the lighting level below predetermined levels in an emergency.

An apparatus is provided to operate as a normal light fixture in a first state and to switch to operate as an emergency light fixture in a second state upon the loss of power in proximity to the apparatus. The apparatus does not use additional hardware, such as batteries in the distributed system and a transfer switch in the centralized system described above. In the present example, the apparatus is connected to an emergency power distribution system separate from a normal power distribution system without the use of a transfer switch. Normal light fixtures are connected directly to a normal power distribution system.

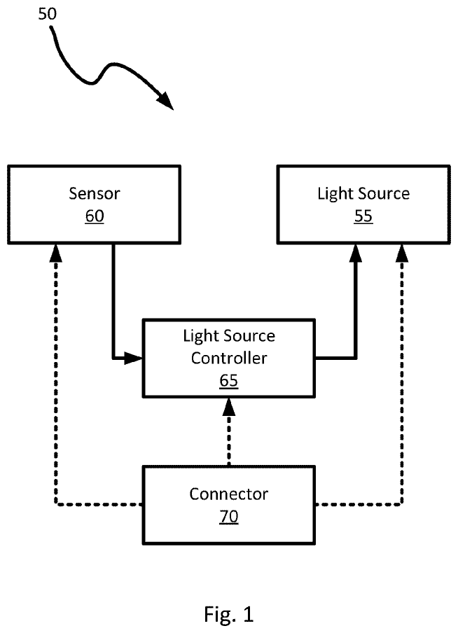

Referring to FIG. 1, a schematic representation of an example of the components of an apparatus to provide emergency lighting during a power outage is generally shown at 50. The apparatus 50 is not particularly limited and may include additional components, such as various additional interfaces and/or input/output devices such as indicators to interact with a user of the apparatus 50. The interactions may include viewing the operational status, updating parameters, or resetting the apparatus 50. In the present example, the apparatus 50 includes a light source 55, a sensor 60, a light source controller 65, and a connector 70.

In the present example, the light source 55 is to illuminate a space. The light source 55 is not particularly limited and may be any device configured to emit light to illuminate the space. The light may be white light or another color suitable for illuminating the space. In some examples, the light source 55 may additionally emit light having a peak wavelength greater than about 780 nm to be beyond the typical visual range of a human eye to transmit infrared or near-infrared signals. The light source 55 may be any device capable of generating light. For example, the light source 55 may be an incandescent light bulb, a fluorescent light bulb, or a light emitting diode. The space which is to be illuminated by the light source 55 is not particularly limited. In the present example, the light source 55 may project a uniform intensity across a portion of a room or project light to illuminate an outdoor space, such as a sports field or stadium.

The sensor 60 is to detect an external signal. In the present example, the external signal is associated with normal operating conditions where an external power source, such as an external power grid supplying electricity, is operating normally. The sensor 60 is not particularly limited and may be any suitable sensor capable of detecting the external signal. In addition, the external signal is not particularly limited and may include any type of signal that can be transmitted wirelessly to the sensor 60 from a proximate emitter, such as a signal of another wavelength able to travel from the emitting device to the apparatus 50. In other examples, the external signal may be an acoustic signal. The selection of the type of external signal to be detected by the sensor 60 is not limited and may be a matter of system design. For example, the wavelength of the electromagnetic signal may be selected with consideration of specific design parameters, such as whether the apparatus 50 is to detect nearby devices through walls, windows, etc.

In the present example, the external signal may be a radio frequency signal from a proximate device, which may be a normal light fixture or another apparatus 50. The external signal emitted from the proximate device may be a pulsed signal, such as a heartbeat signal, that pulses periodically, such as about every second. It is to be appreciated by a person of skill with the benefit of this description that the period of the pulses is not limited and may be longer or shorter in some cases. For example, short periods of pulses may result in the faster detection of a change in state. In particular, some examples may have a continuous external signal instead of a pulsed signal. Alternatively, longer periods of pulsing may result in the conservation of energy. In further examples, the characteristics of the external signal may be used to identify the proximate device from which the external signal originated. For example, the external signal may include a signature characteristic, such as a specific frequency, modulation rate, modulation period, or a combination of characteristics.

The proximate device from which the external signal originates is not particularly limited. In the present example, the proximate device may be a normal light fixture or a device that is substantially similar to the apparatus 50. In the present example, the proximate device is to be powered via a normal power distribution system, such as one connected directly to a power grid. Accordingly, when the power grid loses power or is otherwise disconnected from the proximate device, the proximate device ceases to operate and the generation of the external signal to be received by the sensor 60 stops.

In the present example, the light source controller 65 is to control the light source 55. In the present example, the light source controller 65 is to send command signals to the light source 55 to control the operation of the light source 55. The command signals are not particularly limited and may include commands to turn on and turn off the light source 55. Other functions may include varying the intensity of the light source 55 to adjust the illumination level on the space and/or change the color of emitted light to alter the mood of the lighting in the space. In other examples, the light source 55 may be a simple emitter that does not process commands. In such an example, the light source controller 65 may provide power to the light source 55 or turn on and off the light source 55 by providing and cutting off power. Furthermore, in this example, the light source controller 65 may vary the intensity of the light source 55 by varying the amount of power supplied to the light source 55 to adjust the illumination level of the space and to manage the power consumption of the light source 55 while maintaining suitable illumination levels in the space.

The light source controller 65 is to operate in one of at least two states. The first state in which the light source controller 65 operates is a normal state where the light source controller 65 controls the light source 55 in accordance with a user's preferences. For example, the light source 55 may be operated in a similar manner as proximate devices to provide illumination to a space in accordance with a predetermined set of control parameters. For example, the apparatus 50 may be part of a smart lighting system. In the present example, the light source controller 65 is to operate in this normal state when the sensor 60 detects an external signal from a proximate device.

In cases where the sensor 60 fails to detect the external signal from a proximate device, the light source controller 65 switches from operating in the normal state to operating in a second state. The second state in which the light source controller 65 operates is an emergency state where the light source controller 65 controls the light source 55. It is to be appreciated by a person of skill with the benefit of this description that if the sensor 60 fails to detect the external signal from the proximate device, it is likely that the proximate device is no longer emitting the external signal and therefore not operating normally. If the proximate device is not operating normally, it is likely that the proximate device is no longer illuminating the space properly and that the building may have lost power such that the proximate device is not able to illuminate the space. Without proper illumination in a space, the egress of the building by occupants may become dangerous in situations where the occupants are to exit the building, such as if there is a fire in the building to cause a power outage.

The parameters for operation of the light source controller 65 in the emergency state is not particularly limited. In some examples, the building may be subjected to various regulations, such as to maintain minimum illumination levels by activating the light source 55 upon the loss of power. For example, if the failure to detect the external signal is associated with the loss of power, the light source 55 may be activated for a predetermined period of time to allow for the safe egress of the space. In particular, the light source controller 65 will not accept other control routines, such as a smart lighting routine, to execute while in the emergency state and instead activate and maintain the light source 55 at a predetermined level for the predetermined hold time, such as about 90 minutes, while no external signal is detected.

The manner by which the light source controller 65 switches from the normal state to the emergency state is not limited and may be carried out via a variety of ways. For example, the light source controller 65 may be in a default emergency state unless the external signal is detected by the sensor 60. In this example, as the apparatus 50 is installed and powered on initially, the light source controller 65 will be in the emergency state while the sensor 60 looks for an external signal to switch the light source controller 65 from the emergency state to the normal state. When the light source controller 65 is in the normal state, the light source controller 65 may switch back to the emergency state once the external signal is no longer detected by the sensor 60. For example, the external signal may be considered not detected if the sensor 60 fails to detect an expected pulse when the external signal is a pulsed signal, such as a heartbeat signal. In other examples, the light source controller 65 may consider a predetermined period of time without a detection of the external signal to be a triggering event to switch from the normal state to the emergency state. By waiting a predetermined period of time for an external signal, the number of false alarms triggering the switch from the normal state to the emergency state may be reduced. Upon detecting the external signal by the sensor 60 at a later time, the light source controller 65 may switch back to the normal state.

In the present example, the connector 70 is to receive power from a separate power source operating a proximate device that generates the external signal. In particular, the power source providing power to the connector 70 operates independently from the external power source on which the external signal is generated. Accordingly, a failure of the external power source will not affect the power provided to the connector 70 by the separate power source. The connector 70 is to distribute power received from the power source and provide the power to components of the apparatus 50, such as the light source 55, the sensor 60, and the light source controller 65.

It is to be appreciated by a person of skill with the benefit of this description that although the two states shown in which the light source controller 65 operates is a normal state and an emergency state, the emergency state may not be an actual emergency. The apparatus 50 is configured to be powered by a separate power source and the separate power source may be substantially similar to the power source of the external signal in some examples. For example, the power source providing power to the apparatus 50 may be received from a first transformer station and the power source for the proximate device may be received from a second transformer station. In this example, the operation the apparatus 50 may be used to compensate for lower illumination levels if the proximate device loses power. Similarly, if the proximate device is substantially the same as the apparatus, the proximate device may be used to compensate for lower illumination levels if the apparatus 50 loses power.

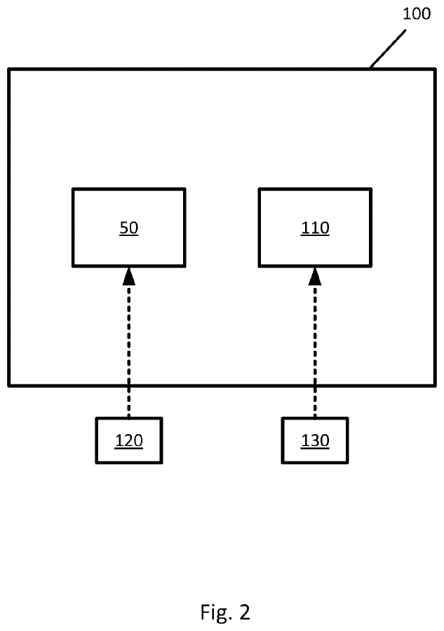

Referring to FIG. 2, a building space 100 with an apparatus 50 and a device 110 is shown. In the present example, the apparatus 50 and device 110 share similar hardware components and operate together to illuminate the building space 100. In other examples, the apparatus 50 and the device 110 may be substantially identical and include the same hardware components for ease of manufacturing. In this example, different hardware components may be activated when operating as the apparatus 50 and from the device 110. The apparatus 50 receives power from a power source 120 and the device is to be powered by the power source 130. The power source 120 and the power source 130 are not particularly limited. However, the power source 120 and the power source 130 are separate and electrically isolated from each other such that events at one power source, such as the power source 130, do not affect the operation at the other power source.

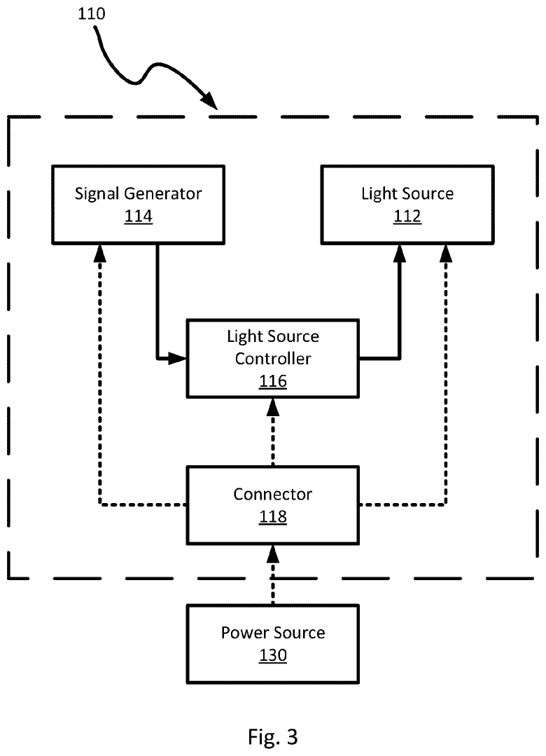

Referring to FIG. 3, a schematic representation of an example of the device 110 to illuminate the space 100 is generally shown. In the present example, the device 110 may be a normal lighting fixture located proximate to the apparatus 50. The device 110 is not particularly limited and may include various components, such as interfaces and/or input/output devices such as indicators to interact with a user of the device 110. The interactions may include viewing the operational status, updating parameters, or resetting the device 110 to perform illumination functions. The device 110 may operate in combination with the apparatus 50. In the present example, the device 110 includes a light source 112, a signal generator 114, a light source controller 116, and a connector 118.

In the present example, the light source 112 is to illuminate the space 100. The light source 112 is not particularly limited and may be any device configured to emit light to illuminate the space 100, similar to those described above in connection with the light source 55. In particular, the light source 112 may be any device capable of generating light and may be substantially identical to the light source 55 to provide consistent light across the space 100. For example, the light source 112 may be an incandescent light bulb, a fluorescent light bulb, or a light emitting diode.

The signal generator 114 is to generate a device signal. In the present example, the device signal is associated with the normal operation of the device 110 where the power source 130, such as an external power grid supplying electricity, is providing power and the light source 112 is operating normally to provide illumination. The device signal is not particularly limited and may include any type of signal that can be broadcasted wirelessly to the space 100. It is to be appreciated by a person of skill with the benefit of this description that the device signal generated by the signal generator 114 may be an external signal detected by the apparatus 50 as discussed above. The selection of the type of device signal to be broadcasted is not limited and may be a matter of the design of the system. For example, the wavelength of the electromagnetic signal may be selected with consideration of specific design parameters, such as whether the apparatus 50 will to be able to detect nearby the device 110 through a wall, windows, etc. In particular, the electromagnetic signal may include an infrared or near infrared signal that cannot pass through barriers, such as a wall, to establish upper limits on proximity and/or co-location. in this example, the infrared or near infrared signal may establish a link between the apparatus 50 and the device 110 while confirming that they are in the same room.

In the present example, the device signal may be a radio frequency signal to be detected by the apparatus 50. The device signal broadcasted from the device 110 may be a pulsed signal, such as a heartbeat signal, that pulses periodically, such as about every second. It is to be appreciated by a person of skill with the benefit of this description that the period of the pulses is not limited and may be longer or shorter in some cases. For example, short periods of pulses may result in the faster detection by the apparatus 50 of a change in the state of the device 110, such as a failure of the power source 130. In some examples, the device 110 may broadcast a continuous device signal instead of a pulsed signal so that a failure may be detected instantly. Alternatively, longer periods of pulsing may result in the conservation of energy. In further examples, the characteristics of the device signal may be used to identify the device 110 to any apparatus 50 detecting the signal or to another device in some examples where more devices are disposed in the space 100. For example, the device signal may include a signature characteristic, such as a specific frequency, modulation rate, modulation period, or a combination of characteristics.

In the present example, the light source controller 116 is to control the light source 112. In the present example, the light source controller 116 is to send command signals to the light source 112 to control the operation of the light source 112. The command signals are not particularly limited and may include commands to turn on and turn off the light source 112. Other functions may include varying the intensity of the light source 112 to adjust the illumination level in the space 100 and/or changing the color of emitted light to alter the mood of the lighting in the space 100. In other examples, the light source 112 may be a simple emitter that does not process commands. In such an example, the light source controller 116 may provide power to the light source 112 or turn on and off the light source 112 by providing and cutting off power. Furthermore, in this example, the light source controller 116 may vary the intensity of the light source 112 by varying the amount of power supplied to the light source 112 to adjust the illumination level of the space and to manage the power consumption of the light source 112 while maintaining suitable illumination levels in the space 100.

In the present example, the connector 118 is to receive power from the power source 130. In particular, the power source 130 operates independently and is electrically isolated from the power source 120 as discussed earlier. Accordingly, a failure of the power source 130 causes the device 110 to cease operating such that the device signal from the signal generator 114 stops. The connector 118 is to distribute power received from the power source 130 and provide the power to components of the device 110, such as the light source 112, the signal generator 114, and the light source controller 116.

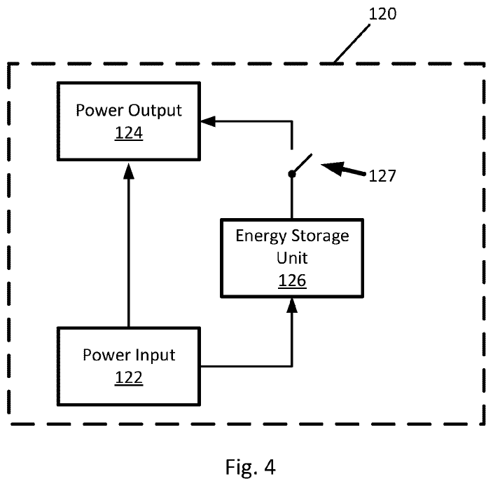

Referring to FIG. 4, a schematic representation of an example of the components of the power source 120 to power the apparatus 50 is generally shown. In the present example, the power source 120 may be an uninterruptible power supply. The power source 120 is not particularly limited and may include various components, such as interfaces and/or input/output devices such as indicators located on a control panel or circuit breaker box to interact with a user of the power source 120. The interactions may include viewing the operational status, such as the readiness of the system to respond to a loss of power. In the present example, the power source 120 includes a power input 122, a power output 124, an energy storage unit 126, and a switch 127.

Under normal operation, the power input 122 is connected to an external power grid and receives power from the power grid. The power is passed through to the power output 124 which connects to the apparatus 50 via a connector 70. The power input 122 also provides power to charge an energy storage unit 126 during normal operation. During a power failure where the power received at the power input 122 drops below a predetermined threshold, the switch 127 closes and that energy storage unit 126 provides power to the power output 124 for subsequent distribution to the apparatus 50.

It is to be appreciated by a person of skill that the energy storage unit 126 is not particularly limited. For example, the energy storage unit 126 may be a lithium ion battery, a nickel-cadmium battery, or other type of rechargeable battery. In some examples, the energy storage unit 126 may be a capacitor. The energy storage unit 126 is generally configured to have sufficient storage to power the apparatus 50 and any other similar devices connectors to the power source 120 for a predetermined period of time when the power input 122 does not receive power, or sufficient power from the external source.

In the present example, the power source 120 is to provide power to the apparatus 50 while the power source 130 is connected directly to an external power grid, which may be the same grid supplying power to the power input 122 of the power source 120. Upon a power failure of the external power grid, which includes a reduction in power below a predetermined threshold to provide sufficient illumination in the space 100, the power source 130 will not be able to supply sufficient power to the device 110. Meanwhile, the power source 120 will close the switch 127 and continue providing emergency power from the energy storage unit 126 to the apparatus 50. Since the devices 110 will not be operating, the apparatus 50 will not detect the signal from the devices and switch to the emergency state as described above to provide lighting during a power outage.

Although the present example shows a small space with a single apparatus 50 and a single device 110, it is to be appreciated that in other examples, there may be more apparatuses 50 and devices 110 disposed throughout the space 100. Furthermore, the space 100 is not particularly limited and may be a room, a building, a plurality of buildings, or an outdoor space. In examples with more apparatuses 50 and devices 110, each apparatus 50 is to be connected to the same power source 120 and each device 110 is to be connected to the power source 130. Accordingly, the power source 120 is generally connected to a plurality of apparatuses 50 in a building in parallel to provide power and the power source 130 is generally connected in parallel to devices 110 in a building to provide power. Therefore, when an external power grid fails, the devices 110 cease to broadcast a signal and the apparatuses 50 switch to the emergency state to provide emergency lighting.

The distribution of the apparatuses 50 within a building among devices 110 is not particularly limited and may be varied based on the design of the overall system. Similarly, the ratio of apparatuses 50 to devices 110 is not limited. For example, the ratio of apparatuses 50 to devices 110 may be 1:5 to provide safe egress of a space. In other examples, the ratio of apparatuses 50 to devices 110 may be lower, such as 1:10, when the design of a space allows for fewer apparatuses 50 to maintain the threshold illumination level in a space during an emergency.

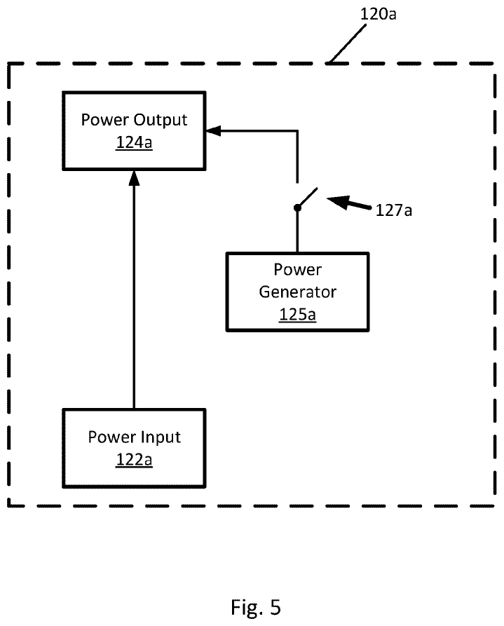

Referring to FIG. 5, another schematic representation of an example of the components of the power source 120a to power the apparatus 50 is generally shown. Like components of the power source 120a bear like reference to their counterparts in the power source 120, except followed by the suffix “a”. In the present example, the power source 120a includes a power input 122a, a power output 124a, a power generator 125a, and a switch 127a.

The power source 120a is substantially similar to the power source 120 except the energy storage unit 126 is replaced with a power generator 125a capable of providing power when the power input 122a fails to receive sufficient power from the external power grid. The power generator 125a is not particularly limited and may include a conventional gas, diesel, or natural gas generator. In other examples, the power generator 125a may be paired with an energy storage device to allow for alternative sources of power generation such as wind or solar.

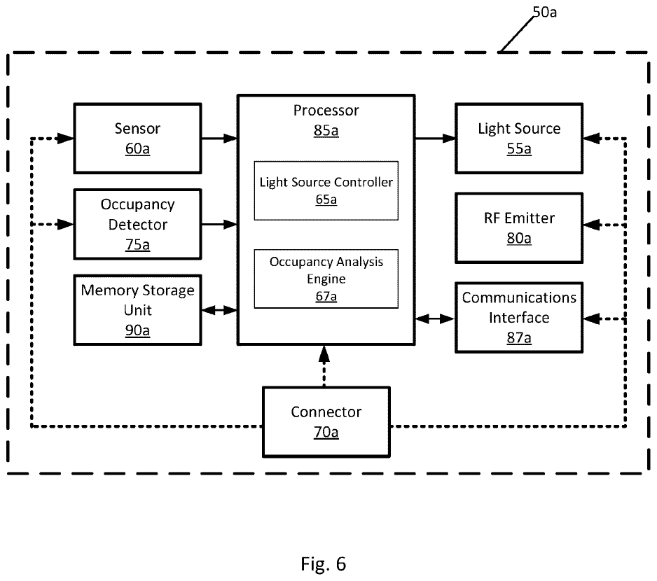

Referring to FIG. 6, another schematic representation of an example of the components of an apparatus 50a to provide emergency lighting during a power outage is generally shown. Like components of the apparatus 50a bear like reference to their counterparts in the apparatus 50, except followed by the suffix “a”. In the present example, the apparatus 50a includes a light source 55a, a sensor 60a, a connector 70a, an occupancy detector 75a, a radio frequency emitter 80a, a processor 85a, a communications interface 87a, and a memory storage unit 90a.

The present example includes an occupancy detector 75a connected to the processor 85a. The occupancy detector 75a is to detect occupancy in a space within a field of view of the occupancy detector 75a. In particular, the occupancy detector 75a collects data within a field of view. The data is provided to the occupancy analysis engine 67a executed by the processor 85a to determine if the space is occupied. In some examples, the determination made by the occupancy detector 75a may be used when the light source controller 65a is operating in the normal mode. Accordingly, the determination by the occupancy detector 75a may be used to operate the light source 55a in accordance with the lighting protocols of a smart lighting system, such as dimming or shutting off the light source 55a when the space is not occupied.

In other examples, the determination of the occupancy detector 75a may also be used in the emergency state. For example, when in the emergency state, the light source controller 65a may maintain the light source 55a at a predetermined level for the predetermined hold time. In this example, the calculation of the hold time may begin once no more occupancy is detected, or the light source controller 65a may check to ensure there is no more occupancy after the predetermined hold time. It is to be appreciated by a person of skill with the benefit of this description that by confirming that a space is not occupied before dimming or turning off the emergency lighting, situations that may cause a longer than anticipated egress of a building will not lose illumination during the egress. Furthermore, by dimming an apparatus 50a in an area of a building after the predetermined hold time where egress has been completed will conserve the energy stored in the power source so that other apparatuses receiving power from the power source may operate for a longer period of time. In addition, if emergency responders enter the building after the predetermined hold time, the occupancy detector 75a may detect the occupancy and turn the emergency lighting back on for the responders.

The radio frequency emitter 80a is to emit a radio frequency signal that is broadcasted to proximate external devices. The radio frequency signal is not particularly limited and may include identifying information of the apparatus 50a. In some examples, the radio frequency emitter 80a emits a heartbeat signal to proximate devices to establish a connection and to be grouped with other devices during operation in the normal state. Once a connection to a proximate external device is established, the apparatus 50a and external devices may be grouped autonomously and operated as a smart lighting system.

In the present example, the processor 85a may include a central processing unit, a microcontroller, a microprocessor, a processing core, a field-programmable gate array, an application-specific integrated circuit, or similar. The processor 85a may cooperate with the memory storage unit 90a to execute various instructions stored thereon. For example, the memory storage unit 90a may store an operating system that is executable by the processor 85a to provide general functionality to the apparatus 50a, including functionality to execute the light source controller 65a and the occupancy analysis engine 67a. The processor 85a is also connected to various components of the apparatus 50a and may receive data and/or send commands to the components.

In the present example, the processor 85a may carry out instructions to implement various components of the apparatus 50a. For example, the processor 85a may be programmed to carry out the functionality of the light source controller 65a and the occupancy analysis engine 67a. In addition, the processor 85a may be programmed to send and receive data via the communications interface 87a and to read and write data from the memory storage unit 90a. In addition to controlling the operation of the light source 55a, the light source controller 65a may also control the light generated by a proximate device. For example, the light source controller 65a may generate a command to be transmitted to a proximate device via the communications interface 87a. In particular, the command may cause the proximate device to change the illumination level in a space. The command may be broadcasted to more than one device within range and include device identifiers to identify the group of proximate devices to which the command is targeted.

The manner by which the light source controller 65a controls the light in the normal state is not limited. For example, the processor 85a may receive data from the sensor 60a and the occupancy detector 75a for the light source controller 65a and the occupancy analysis engine 67a to process, respectively. Based on the results of the analysis, the light source controller 65a may send commands to the light source 55a to control the illumination in the space in coordination with external devices. In addition, the processor 85a may read and write data from the memory storage unit 90a to store historical data which may be reviewed or used as data to further train the operation of the light source controller 65a.

In the present example, the communications interface 87a is to communicate with an external device. The external devices are not particularly limited and may be disposed at various locations within an area or building, such as within one or more rooms, and within communication range of the apparatus 50a. The external devices may be any type of device in the smart lighting system. For example, the external device may be another apparatus 50, a lighting device 110, a wall mounted or remote lighting controller, or a central server. The communication range of the communications interface 87a is not particularly limited and may vary depending on different factors, such as barriers that may interfere with the transmission of signals. In other examples, the communication range may also be extended with relay devices.

The data received from the communications interface 87a may include data about proximate devices. In particular, the data received may include a distance as well as a bearing associated with each proximate device and be used in the provisional stage of the apparatus 50a as well as during operation to receive commands to coordinate operation in a space with other proximate devices. The communications interface 87a may also be used in some examples to transmit a command or control signal to the external devices. The commands transmitted to the external devices is not particularly limited and may be directed to a specific device or group of devices. For example, each command transmitted by the apparatus 50a may include a device identifier associated with the command. Accordingly, the apparatus 50a may be used to control proximate devices to coordinate the illumination of the space.

The manner by which the communications interface 87a communicates with the external devices is not particularly limited. In the present example, the communications interface 87a may communicate with devices over a network, which may be a public network shared with a large number of connected devices, such as a WiFi network or cellular network. In other examples, the communications interface 87a may be a wireless interface to transmit and receive wireless signals directly to external devices via a Bluetooth connection, radio signals, or infrared signals and subsequently relayed to additional devices.

The memory storage unit 90a is used to store additional data to be used by the processor 85a as well as persistent data. For example, the memory storage unit 90a may store network data, such as mapping data, or information relating to other devices, such as identifiers, connected to a decentralized network. In the present example, the memory storage unit 90a may include a non-transitory machine-readable storage medium that may be any electronic, magnetic, optical, or other physical storage device. In other examples, the memory storage unit 90a may be an external unit, such as an external hard drive, or a cloud service providing content. The memory storage unit 90a may also be used to store instructions for general operation of the apparatus 50a. In particular, the memory storage unit 90a may store an operating system that is executable by a processor 85a to provide general functionality to the apparatus 50a. The memory storage unit 90a may additionally store instructions to operate the light source controller 65a and the occupancy analysis engine 67a. Furthermore, the memory storage unit 90a may also store control instructions to operate other components and peripheral devices of the apparatus 50a, such the light source 55a, the sensor 60a, connector 70a, occupancy detector 75a, radio frequency emitter 80a, communications interface 87a, and any other additional components of the apparatus 50a.

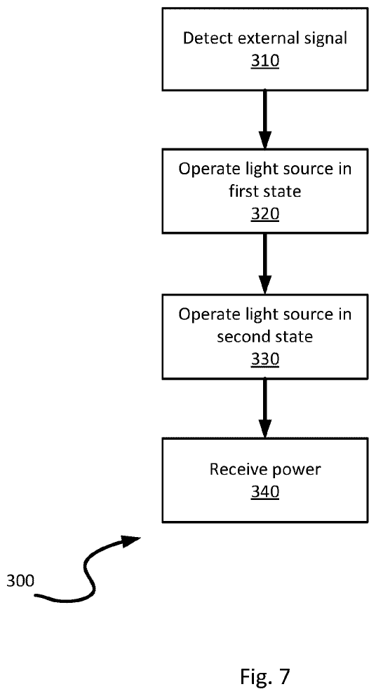

Referring to FIG. 7, a flowchart of an example method of providing emergency lighting during a power outage is generally shown at 300. In order to assist in the explanation of method 300, it will be assumed that method 300 may be performed by the apparatus 50 and the device 110. Indeed, the method 300 may be one way in which the apparatus 50 and the device 110 are configured. Furthermore, the following discussion of method 300 may lead to a further understanding of the apparatus 50 and its components.

Beginning at block 310, an external signal is to be detected by the sensor 60. In the present example, the source of the external signal is another proximate device 110. In particular, the device 110 is to be powered by a separate power source 130 from the power source 120 of the apparatus 50.

Block 320 involves operating the light source 55 of the apparatus 50 in a normal state where both the power source 120 and the power source 130 are providing power to the apparatus 50 and the device 110, respectively. In the normal state, the light source controller 65 operates the light source 55 in accordance with a user's preferences for illumination levels in a space. For example, the light source 55 may be operated in a coordinated manner with proximate devices to provide illumination to a space in accordance with a predetermined set of control parameters. The illumination may automatically adjust for various factors such as ambient light, time of day usage, etc. Accordingly, the apparatus 50 may be part of a smart lighting system.

At block 330, the operation of the light source 55 switches to an emergency state when the signal detected at block 310 ceases to be detected by the sensor. When the external signal stops, it is to be assumed that the power source 130 of the external signal has lost power. However, since the apparatus 50 receives power from the power source 120 at block 340, the apparatus 50 continues to operate in the emergency state. The specific operation of the light source 55 in the emergency state is not particularly limited. For example, the light source controller 65 may not accept other control routines, such as a smart lighting routine. Instead, the light source controller 65 will maintain the light source 55 at a predetermined level for the predetermined hold time to allow for the safe egress of the space.

Various advantages will now become apparent to a person of skill with the benefit of this description. For example, the apparatus 50 may be used as part of a system to provide emergency lighting in an efficient manner without the use of specialized backup systems or transfer switches at the device level. The present apparatus also allows dispensing with transfer switches for the power source that are used in some systems.

It should be recognized that features and aspects of the various examples provided above may be combined into further examples that also fall within the scope of the present disclosure.

1. An apparatus comprising:
a light source to illuminate a space;
a sensor to detect an external signal, wherein the external signal is powered by a first power source;
a light source controller to control the light source, wherein the light source controller is to operate the light source in a first state when the sensor detects the external signal, and wherein the light source controller is to operate the light source in a second state when the sensor fails to detect the external signal; and
a connector to receive power from a second power source, wherein the power is provided to the light source, the light source controller, and the sensor, and wherein the second power source is separate from the first power source.

2. The apparatus of claim 1, wherein the light source controller defaults to the second state when powered on.

3. The apparatus of claim 1, wherein the light source controller switches from the first state to the second state after a predetermined period of time without a detection of the external signal.

4. The apparatus of claim 1, wherein the light source controller in the second state activates the light source for a predetermined hold time.

5. The apparatus of claim 4, further comprising an occupancy detector to detect occupancy in the space, wherein the light source controller reduces power to the light source after the predetermined hold time from an occupancy detection.

6. The apparatus of claim 1, further comprising an emitter to emit a heartbeat signal, wherein the heartbeat signal is to establish a connection with an external device.

7. The apparatus of claim 1, wherein the second power source is an uninterrupted power supply.

8-9. (canceled)

10. A system comprising:
a first device comprising:
a first light source to illuminate a space;
a signal generator to generate a device signal, wherein the device signal is broadcasted to the space to indicate a normal operation of the first device; and
a first light source controller to control the first light source;
a second device comprising:
a second light source to illuminate the space;
a sensor to detect the device signal; and
a second light source controller to control the second light source, wherein the second light source controller is to operate the second light source in a first state when the sensor detects the device signal to indicate normal operation of the first device, and wherein the second light source controller is to operate the second light source in a second state when the sensor fails to detect the device signal;
a first power source to power the first device; and
a second power source to power the second device, wherein the first power source and the second power source are electrically isolated.

11. The system of claim 10, wherein the second light source controller defaults to the second state when powered on.

12. The system of claim 10, wherein the second light source controller switches from the first state to the second state after a predetermined period of time without a detection of the device signal.

13. The system of claim 10, wherein the second light source controller in the second state activates the second light source for a predetermined hold time.

14. The system of claim 13, wherein the second device further includes an occupancy detector to detect occupancy in the space, wherein the second light source controller reduces power to the second light source after the predetermined hold time from an occupancy detection.

15. The system of claim 10, wherein the second power source is an uninterrupted power supply.

16-17. (canceled)

18. A method comprising:
detecting an external signal via a sensor, wherein the external signal is generated by an external device powered by a first power source;
operating a light source in a first state when the external signal is detected;
operating the light source in a second state when the external signal is unable to be detected by the sensor; and
receiving power from a second power source to power the light source, wherein the second power source is separate from the first power source.

19. The method of claim 18, further comprising defaulting to the second state when the light source is powered on.

20. The method of claim 18, further comprising switching from the first state to the second state after a predetermined period of time without a detection of the external signal.

21. The method of any one of claim 18, wherein operating the light source in a second state comprises activating the light source for a predetermined hold time.

22. The method of claim 21, further comprising:
detecting occupancy in a space; and
reducing power to the light source after the predetermined hold time from an occupancy detection.

23. The method of claim 18, further comprising emitting a heartbeat signal to establish a connection with the external device.

24. The method of claim 18, wherein receiving power from a second power source comprises receiving power from an uninterrupted power supply.

25-32. (canceled)
